(19) United States
(12) Patent Application Publication
(10) Pub. No.: US 2003/0079053 A1
(43) Pub. Date: Apr. 24, 2003

(54) System and method for evaluating effectiveness of network configuration management tools

(76) Inventors: Kevin Burns, Colorado Springs, CO (US); Jeff Chapman, Cascade, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/037,892

(22) Filed: Oct. 23, 2001

(51) Int. Cl. G06F 17/60

(52) U.S. Cl. 709/330

(57) ABSTRACT

A system and method for determining resource requirement reduction in a communication network that is realizable through a network configuration management tool. In one embodiment, the disclosed system comprises a system for evaluating a network management tool, the system comprising: a configuration management request (CMR) cost calculator; a problem management request (PMR) cost calculator; a service creation accelerated revenue (SCAR) cost calculator; and an evaluator in communication with the CMR cost calculator, the PMR cost calculator, and the SCAR cost calculator.

### RELATED APPLICATIONS

The present application is related to commonly owned and assigned application Nos.:

Ser. No. 09/730,864, entitled System and Method for Configuration, Management and Monitoring of Network Resources, filed Dec. 6, 2000;

Ser. No. 09/730,680, entitled System and Method for Redirecting Data Generated by Network Devices, filed Dec. 6, 2000;

Ser. No. 09/730,863, entitled Event Manger for Network Operating System, filed Dec. 6, 2000;

Ser. No. 09/730,671, entitled Dynamic Configuration of Network Devices to Enable Data Transfers, filed Dec. 6, 2000;

Ser. No. 09/730,682, entitled Network Operating System Data Directory, filed Dec. 6, 2000;

Ser. No. 09/799,579, entitled Global GUI Interface for Network OS, filed Mar. 6, 2001;

CNTW-007, entitled System and Method for Generating a Configuration Schema, filed Aug. 29, 2001; and

CNTW-008, entitled System and Method for Modeling a Network Device's Configuration, filed Aug. 29, 2001.

all of which are incorporated herein by reference.

### FIELD OF THE INVENTION

The present invention relates to systems and methods for evaluating network configuration management tools. In particular, but not by way of limitation, the present invention relates to systems and methods for evaluating resource consumption by a communication network and for evaluation the reduction in resource consumption achievable through a network configuration management tool.

### BACKGROUND OF THE INVENTION

As communication networks have grown in size and complexity, the difficulties in managing and configuring those networks have also grown. To address these difficulties, many new systems and methods for managing and configuring networks have been developed recently. One such system involves directory enabled networking and is described in commonly owned and assigned patent application Ser. No. 09/730,864, entitled System and Method for Configuration, Management and Monitoring of Network Resources, filed Dec. 6, 2000.

Although network administrators would like to adopt cost-saving network configuration management tools, these network administrators often have difficulty in calculating the potential savings offered by particular tools and in comparing one tool with another. The inability to evaluate savings accurately and to compare one network management tool with another efficiently can cause network administrators to select less than optimal tools or to avoid selecting any tool. As can be appreciated, a wrong choice or no choice at all can be costly in many cases. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for evaluating network configuration management tools. For example, the present invention can evaluate a network configuration management tool by computing a configuration management request (CMR) cost for the network being evaluated. This CMR cost can then be adjusted by the operating efficiency (e.g., what is the expected reduction in labor/cost to address the CMRs) of the network configuration management tool being evaluated, thereby calculating an adjusted CMR and illustrating the resource reduction/cost savings that can be achieved with the network configuration management tool.

Similarly, embodiments of the present invention can also calculate a problem maintenance request (PMR) cost. The PMR cost can then be adjusted by the operating efficiency of the network configuration management tool. This adjusted PMR cost along with the adjusted CMR cost can then be used to calculate an adjusted operational cost or a savings realization cost realizable through the network configuration management tool. The adjusted operational cost and/or the cost savings realization can be used to evaluate the network configuration management tool in a variety of ways. For example, one embodiment of the present invention could calculate a return on investment (ROI) from the costs associated with the network configuration management tool and the cost savings realization. The methods for calculating a general ROI are well known and thus not described in detail herein.

Other embodiments of the present invention can consider additional factors in evaluating the benefits of network configuration management tools. For example, certain embodiments can consider the costs avoided by eliminating the need for other configuration management software licenses and software maintenance support. In other embodiments, the reduction in internal communication costs realized through the network configuration management tool can be considered, and in yet other embodiments, accelerated revenue realized through faster service installation, as enabled by the network configuration management tool, can be considered. For example, increased revenue realized by more quickly activating new customer services can be calculated and considered.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a flowchart illustrating one method of operation according to the present invention;

FIG. 2 is a flowchart illustrating one method of calculating a network's total cost of ownership;

FIG. 3 is a flowchart illustrating one method of calculating cost avoidance offered by a network configuration management tool;

FIG. 4 is a flowchart illustrating one method of calculating service creation accelerated revenue; and

FIG. 5 is a block diagram of one system in accordance with the principle of the present invention.

### DETAILED DESCRIPTION

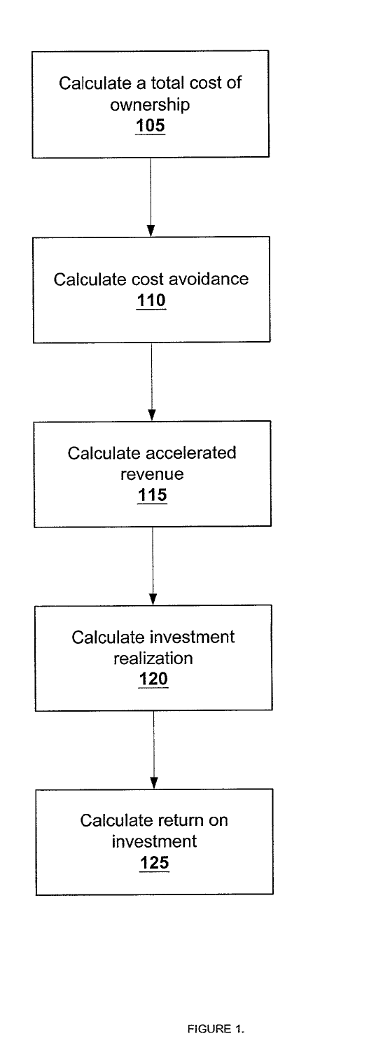

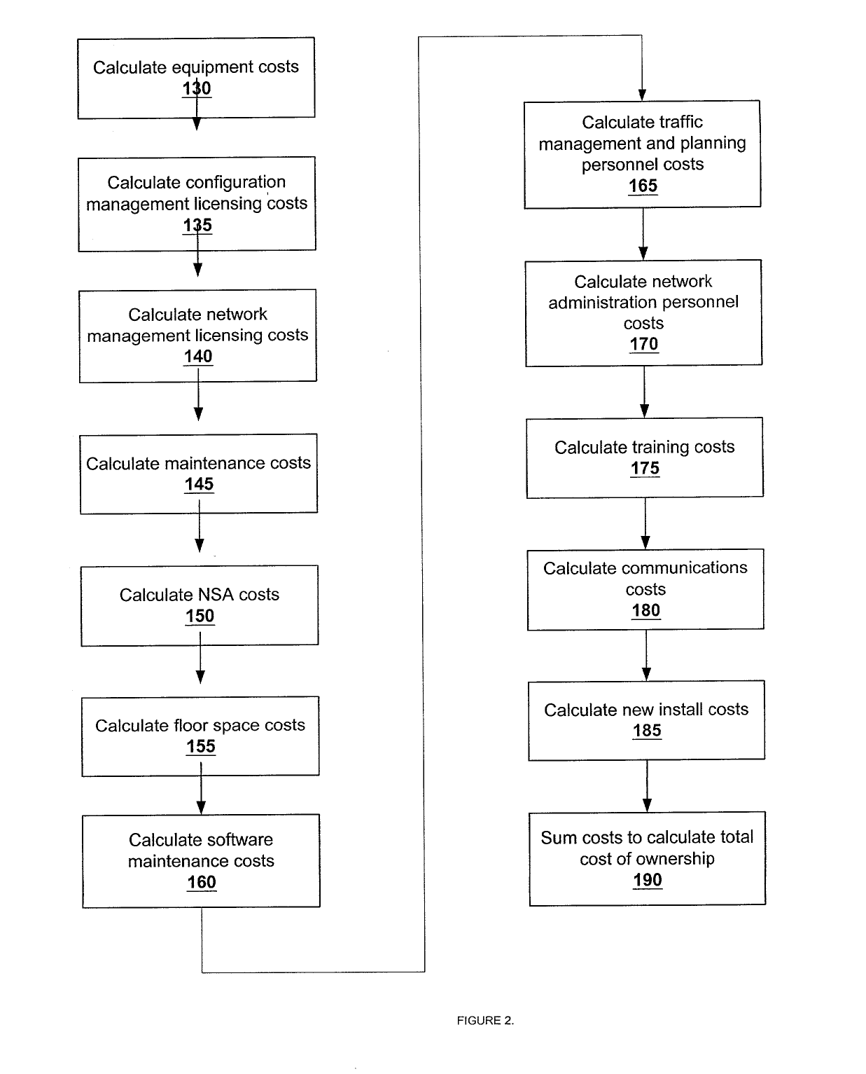

Referring now to the drawings, where like or similar elements are designated with identical reference numerals throughout the several views, and referring in particular to FIG. 1, it illustrates one method of operation according to the present invention. In this method, a total cost of ownership (TCO) for a network can be initially calculated (step 105). (Note that the described order of these steps is exemplary only.) One method for calculating a network's TCO is shown in detail by FIG. 2. Although not limiting, variables that the present invention can account for when calculating a TCO include: equipment, maintenance contracts, NSA contracts, floor space, software maintenance contracts, traffic management and planning personnel, network administration personnel, training, communications, new installations, etc. Using these variables, additional variables, or some subset of these variables, general accounting principles can be applied to compute the TCO.

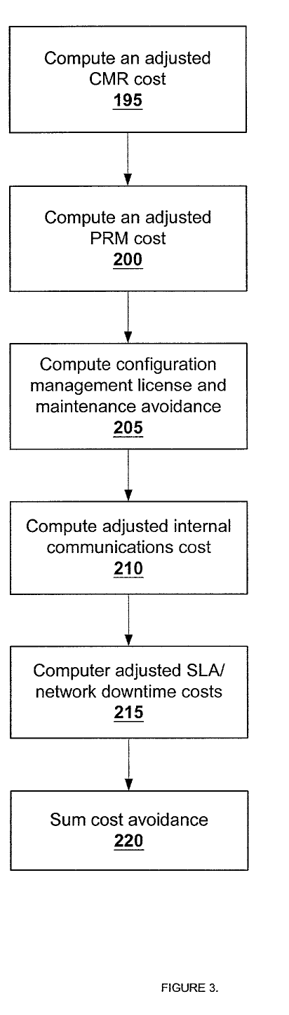

In addition to calculating the TCO, one embodiment of the present invention can calculate the costs that can be avoided through the network configuration tool being evaluated (step 110). Typical cost avoidance factors include configuration management request (CMR) cost avoidance, problem management request (PMR) cost avoidance, and service level agreement (SLA)/network downtime costs. These factors and their calculation are described in more detail with relation to FIG. 3.

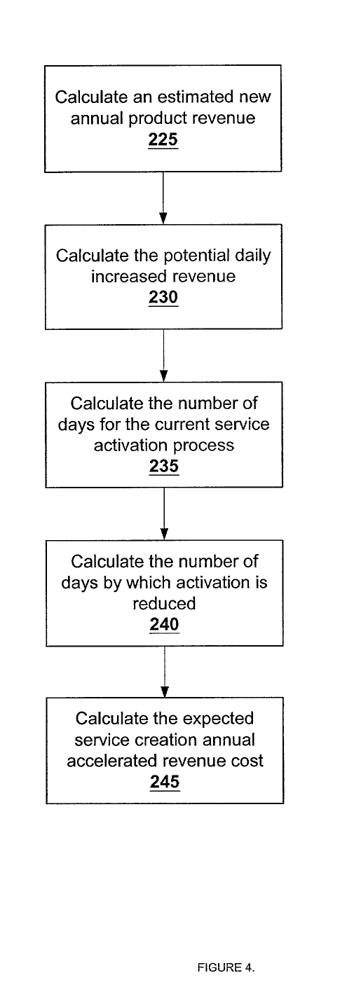

Other embodiments of the present invention can also calculate a projected service creation accelerated revenue (SCAR) that could be realized through the network configuration management tool being evaluated (step 115). The SCAR represents revenue realized from bringing network services online faster through the use of the network configuration management tool being evaluated. For example, a network configuration management tool can enable the realization of accelerated revenue by establishing a customer's network service in fewer days than required without the network configuration management tool. The SCAR and its calculation is described in more detail with relation to FIG. 4.

Using the calculated cost avoidance and the calculated SCAR, the present invention can calculate an investment realization, e.g., payback, offered by the network configuration management tool being evaluated (step 120). This investment realization can be calculated as the sum of the cost avoidance and the SCAR and can be used to evaluate the network management tool in a variety of ways. For example, the calculated investment realization can be compared against the previously calculated TCO to generate a return on investment (ROI) value (step 125). Alternatively, the calculated investment realization can be used to compare one network configuration management tool with another.

Referring now to FIG. 2, it is a flowchart illustrating one method of calculating a TCO for a communication network. In this embodiment, several variable ownership costs can be calculated and summed (step 190). For example, equipment costs such as LAN and router costs can be calculated (step 130). Additionally, any discount given to high volume network equipment purchasers can be considered in calculating equipment costs. Other variable costs include: maintenance contracts, NSA contracts, floor space, software maintenance contracts, traffic management and planning personnel, network administration personnel, training, communications, new installations, etc. (steps 135-185). Notably, the list of variables can be changed to address a particular network and/or a particular network provider.

Referring now to FIG. 3, it is a flowchart illustrating one method of calculating the cost avoidance offered by a network configuration management tool. In this embodiment, an adjusted CMR cost can be initially calculated (step 195). The adjusted CMR cost represents the CMR cost associated with a network being managed by the network configuration management tool being evaluated.

To calculate the adjusted CMR costs, the number of configuration changes per period, e.g., per year, are multiplied by the labor costs for implementing each configuration change. The resultant of that multiplication is the total cost per period for handling CMRs. This total cost can then be multiplied by an operational efficiency factor associated with the network configuration management tool. The resultant of this multiplication represents the adjusted CMR cost. Notably, the operational efficiency factor can be provided by the manufacturer of the network configuration management tool or can be estimated by the administrator for the communication network.

In another embodiment, the resultant of the total CMR cost multiplied by the operational efficiency factor represents the cost avoidance realized with the configuration management tool. Whether the final result of the multiplication represents the CMR cost avoidance or the adjusted CMR cost, either value can be used to evaluate the network management tool. One skilled in the art can easily alter the operational efficiency factor so that the resultant of multiplying the total CMR cost and the operational efficiency represents the cost avoided rather than the adjusted CMR cost. Accordingly, the conversion of the operational efficiency factor is not further described.

In addition to calculating an adjusted CMR cost, the present invention can also calculate an adjusted PMR cost (step 200). The adjusted PMR cost represents the PMR cost associated with a network being managed by the network configuration management tool. In one embodiment, the non-adjusted PMR cost is evaluated by first calculating a rework cost. This rework cost is the resultant of multiplying the number of PMRs by the percent of PMRs caused by errors in addressing CMRs without the network configuration management tool. This rework cost can be multiplied by an operational efficiency factor, which is not necessarily the same as the operational efficiency factor associated with the adjusted CMR cost, to generate an adjusted PMR. As can be appreciated by those skilled in the art, by modifying the operational efficiency factor, a PMR cost avoidance can be calculated rather than an adjusted PMR.

Still referring to FIG. 3, certain embodiments of the present invention can also account for other network costs that can be avoided through the network configuration management tool being evaluated. For example, one embodiment can calculate the cost avoided by not needing configuration management software and related maintenance (step 205). Another embodiment of the present invention can calculate an adjusted internal communication cost that accounts for lost network resources that can be reclaimed by the network management configuration tool (step 210). Yet other embodiments calculated adjusted SLA/network downtime costs (step 215). Once the adjusted costs or cost savings have been calculated, the individual items can be summed to compute a total adjusted cost/cost savings (step S220). This figure can be used to evaluate the resource and cost savings offered by the network configuration management tool being evaluated.

Referring now to FIG. 4, it is a flowchart illustrating one method of calculating service creation accelerated revenue (SCAR). In this embodiment, the present invention can estimate the new annual product revenue for establishing network services for new and existing customers (step 225). This estimated new annual product revenue can be reduced to a periodic unit such as estimated new product revenue per day (step 230). Assuming that the network configuration management tool can decrease the number of days required to enable a new network service (step 240), that decrease can be multiplied by the estimated new product revenue per day to generate the annualized accelerated revenue increase that is realizable through the network configuration management tool (step 245).

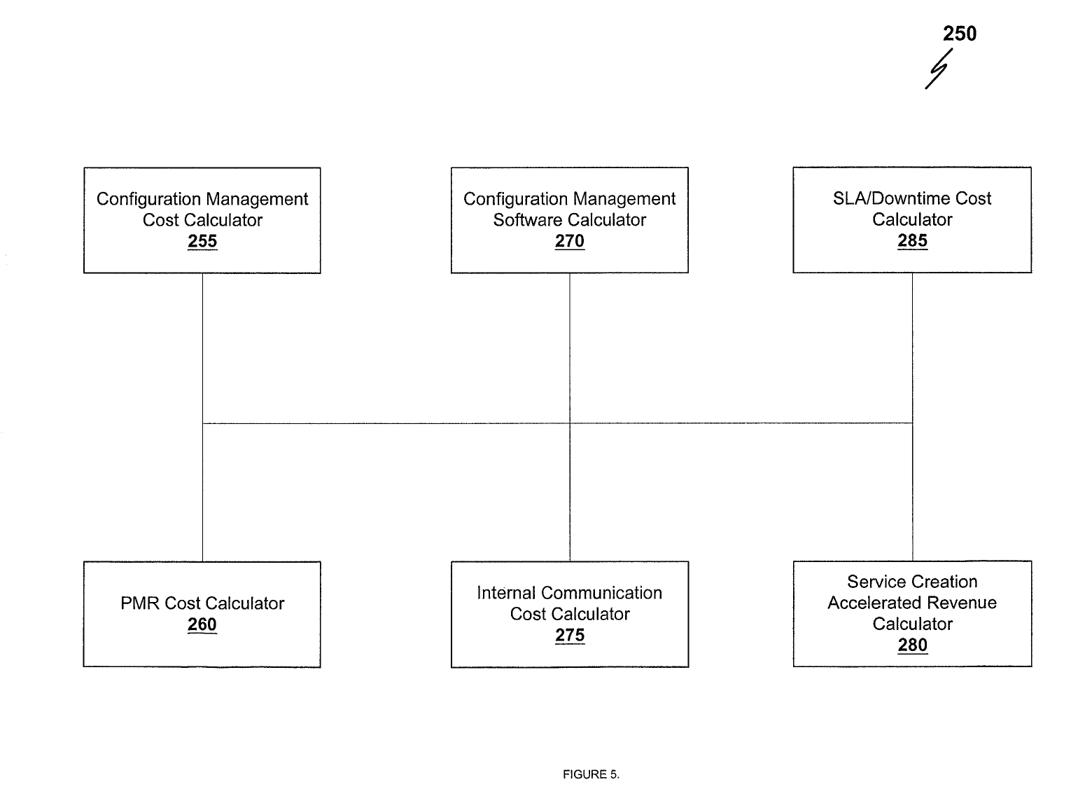

Referring now to FIG. 5, it is a block diagram of one system 250 in accordance with the principal of the present invention. This embodiment includes a configuration management request (CMR) cost calculator 255 that can calculate the CMR costs for a network and/or the adjusted CMR costs for a network. Additionally, this embodiment includes a problem management request (PMR) cost calculator 260 that can calculate the PMR costs for a network and/or the adjusted PMR costs for a network.

Embodiments of the present invention can also include a configuration management software calculator 270 for calculating the costs associated with existing network management devices. Further, embodiments can include an internal communication cost calculator 275 for determining the potential costs that can be avoided by reclaiming network resources that would otherwise be lost without the network configuration management tool being evaluated. Yet other embodiments include SCAR calculators 280 and SLA/downtime cost calculators 285 for calculating costs that can be avoided with the network configuration management tool. Each of the above calculators can use accepted accounting techniques to drive their computations when appropriate.

In conclusion, the present invention provides, among other things, a system and method for evaluation the reduction in resource consumption and network equipment achievable through a network configuration management tool. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A system for evaluating a network management tool, the system comprising:
a configuration management request (CMR) cost calculator;
a problem management request (PMR) cost calculator;
a service creation accelerated revenue (SCAR) cost calculator; and
an evaluator in communication with the CMR cost calculator, the PMR cost calculator, and the SCAR cost calculator.

2. The system of claim 1, further comprising:
a configuration management software calculator, wherein the evaluator is in communication with the configuration management software calculator.

3. The system of claim 1, further comprising:
an internal communication cost calculator, wherein the evaluator is in communication with the internal communication cost calculator.

4. The system of claim 1, further comprising:
an SLA/downtime cost calculator, wherein the evaluator is in communication with the SLA/downtime cost calculator.

5. The system of claim 1, where in CMR calculator comprises:
an adjusted CMR cost calculator.

6. A method for evaluating a network management tool, the method comprising:
calculating a total cost of ownership for a communication network;
calculating a potential cost avoidance realizable through the network management tool;
calculating a potential service creation accelerated revenue realizable through the network management tool; and
determining an evaluation factor for the network management tool, wherein the evaluation factor corresponds to the total cost of ownership, the potential cost avoidance and the potential service creation accelerated revenue.

7. The method of claim 6, further comprising:
calculating an investment realization for the network management tool.

8. The method of claim 6, wherein determining an evaluation factor comprises:
determining a return on investment.

9. The method of claim 6, wherein calculating the potential cost avoidance comprises:
calculating an adjusted PMR cost.

10. The method of claim 6, wherein calculating the potential cost avoidance comprises:
calculating an PRM cost savings realizable through the network management tool.

11. The method of claim 6, wherein calculating the potential cost avoidance comprises:
calculating an adjusted CMR.

12. The method of claim 6, wherein calculating the potential cost avoidance comprises:
calculating a CMR cost savings realizable through the network management tool.

13. The method of claim 6, wherein calculating the potential cost avoidance comprises:
calculating a configuration management license and maintenance avoidance savings.

14. The method of claim 6, wherein calculating the potential cost avoidance comprises:
calculating an adjusted configuration management license and maintenance cost.

15. The method of claim 6, wherein calculating the potential cost avoidance comprises:
calculating an adjusted internal communication cost.

16. The method of claim 6, wherein calculating the potential cost avoidance comprises:
calculating an internal communication cost savings realizable through the network management tool.

17. The method of claim 6, wherein calculating the potential cost avoidance comprises:
calculating an adjusted SLA/downtime cost savings realizable through the network management tool.

18. The method of claim 6, wherein calculating the potential cost avoidance comprises:
calculating an SLA/downtime cost savings realizable through the network management tool.

19. The method of claim 6, wherein the step of calculating the potential service creation accelerated revenue comprises:
calculating an estimated new product revenue for a first period; and
calculating a change in a service activation process.

20. A method for evaluating a network management tool, the method comprising:
calculating a total cost of ownership for a communication network;
calculating a potential cost avoidance realizable through the network management tool; and
determining an evaluation factor for the network management tool, wherein the evaluation factor corresponds to the total cost of ownership and the potential cost avoidance.

21. The method of claim 20, further comprising:
calculating a potential service creation accelerated revenue realizable through the network management tool.

22. The method of claim 21, wherein calculating the potential service creation accelerated revenue comprises:
calculating an estimated new product revenue for a first period; and
calculating a change in a service activation process.

23. The method of claim 20, further comprising:
calculating an investment realization for the network management tool.

24. The method of claim 20, wherein calculating the potential cost avoidance comprises:
calculating an adjusted PMR cost.

25. The method of claim 20, wherein calculating the potential cost avoidance comprises:
calculating an PRM cost savings realizable through the network management tool.

26. The method of claim 20, wherein calculating the potential cost avoidance comprises:
calculating an adjusted CMR.

27. The method of claim 20, wherein calculating the potential cost avoidance comprises:
calculating a CMR cost savings realizable through the network management tool.

28. A system for evaluating a network management tool, the system comprising:
means for calculating a total cost of ownership for a communication network;
means for calculating a potential cost avoidance realizable through the network management tool; and
means for determining an evaluation factor for the network management tool, wherein the evaluation factor corresponds to the total cost of ownership and the potential cost avoidance.

29. The system of claim 28, further comprising:
means for calculating a potential service creation accelerated revenue realizable through the network management tool.
